(19) United States
(12) Patent Application Publication
(10) Pub. No.: US 2026/0138318 A1
(43) Pub. Date: May 21, 2026

(54) INJECTION MOLDING APPARATUS AND MOLD OPENING AND CLOSING DEVICE

(71) Applicant: SEIKO EPSON CORPORATION, Tokyo (JP)

(72) Inventor: Yuki IMAI, MATSUMOTO-SHI (JP)

(21) Appl. No.: 19/369,568

(22) Filed: Oct. 27, 2025

(30) Foreign Application Priority Data
Oct. 28, 2024 (JP) 2024-188831

(51) Int. Cl. B29C 45/80; B29C 45/66

(52) U.S. Cl. CPC B29C 45/80; B29C 45/66; B29C 2945/76013; B29C 2945/7602; B29C 2945/7623; B29C 2945/76387; B29C 2945/76505; B29C 2945/76709; B29C 2945/76866

(57) ABSTRACT

An injection molding apparatus includes an injection unit, a mold opening and closing unit, and a control unit, the mold opening and closing unit includes a fixed mold attachment portion, a movable mold attachment portion, and a mold opening and closing motor, a first fixing portion that fixes a test piece is attachable to the fixed mold attachment portion, a second fixing portion that fixes the test piece is attachable to the movable mold attachment portion, and the control unit performs inspection control to inspect mechanical characteristics of the test piece by applying a compressive force to the test piece by moving the movable mold attachment portion in a mold clamping direction with respect to the fixed mold attachment portion or applying a tensile force to the test piece by moving the movable mold attachment portion in a mold opening direction opposite to the mold clamping direction with respect to the fixed mold attachment portion in a state where the first fixing portion attached to the fixed mold attachment portion fixes a first portion of the test piece and the second fixing portion attached to the movable mold attachment portion fixes a second portion of the test piece different from the first portion.

The present application is based on, and claims priority from JP Application Serial Number 2024-188831, filed October 28, 2024, the disclosure of which is hereby incorporated by reference herein in its entirety.

### BACKGROUND

### 1. Technical Field

The present disclosure relates to an injection molding apparatus and a mold opening and closing device.

### 2. Related Art

JP-A-2024-78705 discloses an injection molding apparatus including a mold clamping unit that opens and closes a movable mold and a fixed mold. JP-A-2023-79657 discloses a tensile tester that applies a tensile force to a test piece and measures mechanical properties such as tensile strength and a yield point of the test piece.

JP-A-2024-78705 and JP-A-2023-79657 are examples of the related art.

The manufacture of the test piece and the inspection of the mechanical characteristics of the test piece are generally performed using different apparatuses. Therefore, there is room for improvement in reducing the number of facilities necessary for manufacturing the test piece and inspecting the mechanical characteristics.

### SUMMARY

According to a first aspect of the present disclosure, an injection molding apparatus is provided. The injection molding apparatus is an injection molding apparatus that performs injection molding of a test piece using a mold including a fixed mold and a movable mold, including an injection unit that injects a material of the test piece into the mold, a mold opening and closing unit to which the mold is attached and that opens and closes the mold, and a control unit that controls the injection unit and the mold opening and closing unit, wherein the mold opening and closing unit includes a fixed mold attachment portion to which the fixed mold is attached, a movable mold attachment portion movable toward and away from the fixed mold attachment portion in a mold clamping direction, to which the movable mold is attached, and a mold opening and closing motor for moving the movable mold attachment portion along the mold clamping direction, a first fixing portion that fixes the test piece is attachable to the fixed mold attachment portion, a second fixing portion that fixes the test piece is attachable to the movable mold attachment portion, and the control unit performs inspection control to inspect mechanical characteristics of the test piece by applying a compressive force to the test piece by moving the movable mold attachment portion in the mold clamping direction with respect to the fixed mold attachment portion or applying a tensile force to the test piece by moving the movable mold attachment portion in a mold opening direction opposite to the mold clamping direction with respect to the fixed mold attachment portion in a state where the first fixing portion attached to the fixed mold attachment portion fixes a first portion of the test piece and the second fixing portion attached to the movable mold attachment portion fixes a second portion of the test piece different from the first portion.

According to a second aspect of the present disclosure, a mold opening and closing device is provided. The mold opening and closing device is a device to which a mold including a fixed mold and a movable mold is attached and that opens and closes the mold, including a fixed mold attachment portion to which the fixed mold is attached, a movable mold attachment portion movable toward and away from the fixed mold attachment portion in a mold clamping direction, to which the movable mold is attached, a mold opening and closing motor for moving the movable mold attachment portion along the mold clamping direction, and a control unit that controls the mold opening and closing motor, wherein a first fixing portion that fixes a test piece is attachable to the fixed mold attachment portion, a second fixing portion that fixes the test piece is attachable to the movable mold attachment portion, and the control unit performs inspection control to inspect mechanical characteristics of the test piece by applying a compressive force to the test piece by moving the movable mold attachment portion in the mold clamping direction with respect to the fixed mold attachment portion or applying a tensile force to the test piece by moving the movable mold attachment portion in a mold opening direction opposite to the mold clamping direction with respect to the fixed mold attachment portion in a state where the first fixing portion attached to the fixed mold attachment portion fixes a first portion of the test piece and the second fixing portion attached to the movable mold attachment portion fixes a second portion of the test piece different from the first portion.

### BRIEF DESCRIPTION OF THE DRAWINGS

FIG. 1 shows a schematic configuration of an injection molding apparatus.

FIG. 2 is a perspective view of a test piece.

FIG. 3 is a cross-sectional view showing schematic configurations of an injection unit and a mold opening and closing unit.

FIG. 4 is another cross-sectional view showing the schematic configuration of the injection unit.

FIG. 5 is a perspective view showing a schematic configuration of a flat screw.

FIG. 6 is a schematic plan view of a barrel.

FIG. 7 shows a schematic configuration of a reducer.

FIG. 8 is a plan view of a first gear and a second gear provided in the reducer as viewed in a -X direction.

FIG. 9 is a perspective view of a mold used for molding the test piece.

FIG. 10 is a perspective view of a first fixing portion and a second fixing portion.

FIG. 11 shows structures of the first fixing portion and the second fixing portion.

FIG. 12 is a graph showing an example of a relationship between torque of a mold opening and closing motor and a compressive force applied to the test piece.

FIG. 13 shows an example of a result of an inspection of mechanical characteristics of the test piece.

### DESCRIPTION OF EMBODIMENTS

### A. First Embodiment:

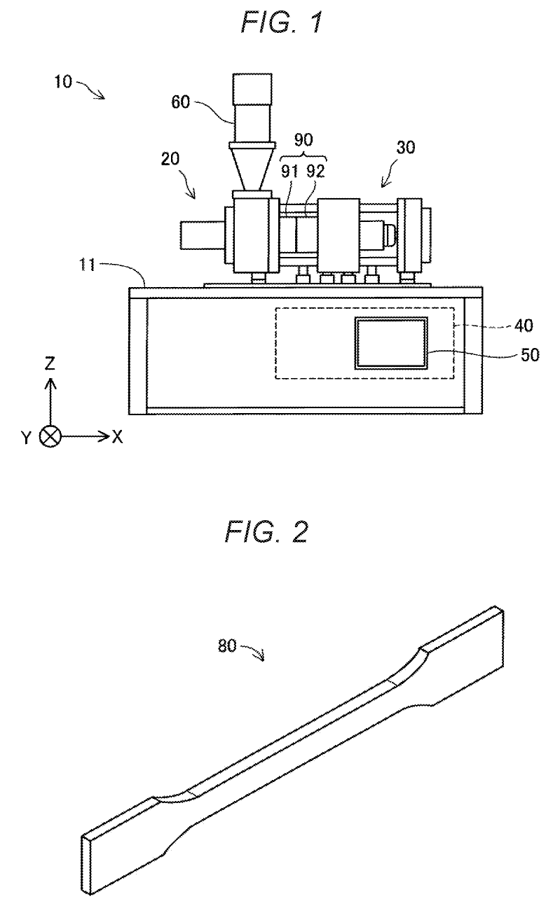

FIG. 1 shows a schematic configuration of an injection molding apparatus 10. FIG. 1 shows arrows indicating X, Y, and Z directions perpendicular to one another. The X direction and the Y direction are parallel to a horizontal plane. The Z direction is parallel to a vertical direction. The X, Y, and Z directions in FIG. 1 and the X, Y, and Z directions in the other drawings indicate the same directions. To specify an orientation, a positive or negative sign is added to the description of the direction, where "+" refers to a positive direction that is a direction indicated by an arrow, and "-" refers to a negative direction that is an opposite direction to the direction indicated by the arrow.

The injection molding apparatus 10 includes an injection unit 20, a mold opening and closing unit 30, a control unit 40, and a display unit 50. The injection unit 20 and the mold opening and closing unit 30 are fixed onto a base 11. The control unit 40 is housed in the base 11. The display unit 50 is fixed to a side surface of the base 11. The injection molding apparatus 10 performs injection molding of a test piece using a mold 90 attached to the mold opening and closing unit 30. The injection molding apparatus 10 inspects the mechanical characteristics of the test piece.

FIG. 2 is a perspective view of a test piece 80. In the present embodiment, the test piece 80 is a dumbbell-shaped plate-like test piece. The test piece 80 may be a dumbbell-shaped rod-like test piece, an arc-shaped test piece, or the like.

The control unit 40 controls the injection unit 20 and the mold opening and closing unit 30. The control unit 40 includes a computer having one or more processors, a memory, and an input-output interface that inputs and outputs signals from and to the outside. The control unit 40 achieves various functions such as a function of executing processing of molding a molded article by the processor executing a program or commands loaded onto a main storage device. Note that the control unit 40 may be implemented by a configuration in which a plurality of circuits for realizing at least a part of each of the functions are combined, instead of being configured with the computer.

The display unit 50 includes, for example, a liquid crystal display. The display unit 50 displays information on the operation of the injection molding apparatus 10. The display unit 50 may be configured as a touch panel.

The mold 90 made of metal is attached to the mold opening and closing unit 30. The mold 90 made of metal is referred to as a metal mold. The mold 90 includes a fixed mold 91 and a movable mold 92. The fixed mold 91 is a mold at a fixed position in a mold clamping operation. The movable mold 92 is a mold that is moved relative to the fixed mold 91 in the mold clamping operation. The movable mold 92 is moved in a direction along a mold clamping direction with respect to the fixed mold 91 by the mold opening and closing unit 30. In the present embodiment, the mold clamping direction is a -X direction. In this specification, a direction opposite to the mold clamping direction is also referred to as a mold opening direction. The mold opening direction is a +X direction. The mold 90 is not limited to one made of metal, and may be one made of resin or ceramic.

A hopper 60 into which a material for a molded article is put is coupled to the injection unit 20. An example of the material for the molded article includes a thermoplastic resin formed in a pellet shape. Examples of the thermoplastic resin include ABS (acrylonitrile butadiene styrene), PC (polycarbonate), POM (polyacetal), PP (polypropylene), and PBT (polybutylene terephthalate). The material for the molded article may contain metal or ceramic in addition to the thermoplastic resin. The supply of the material to the injection unit 20 is not limited to the supply from the hopper 60 but may be performed, for example, via a tube through which the material is pumped.

The injection unit 20 plasticizes at least a part of the material supplied from the hopper 60 to generate a molding material, and injects the generated molding material into the mold 90. In the present specification, "plasticizing" has a concept including melting and refers to changing from a solid state to a state having fluidity. Specifically, in a case of a material in which glass transition occurs, plasticizing refers to setting the temperature of the material to the glass transition point or higher. In a case of a material in which glass transition does not occur, plasticizing refers to setting the temperature of the material to the melting point or higher.

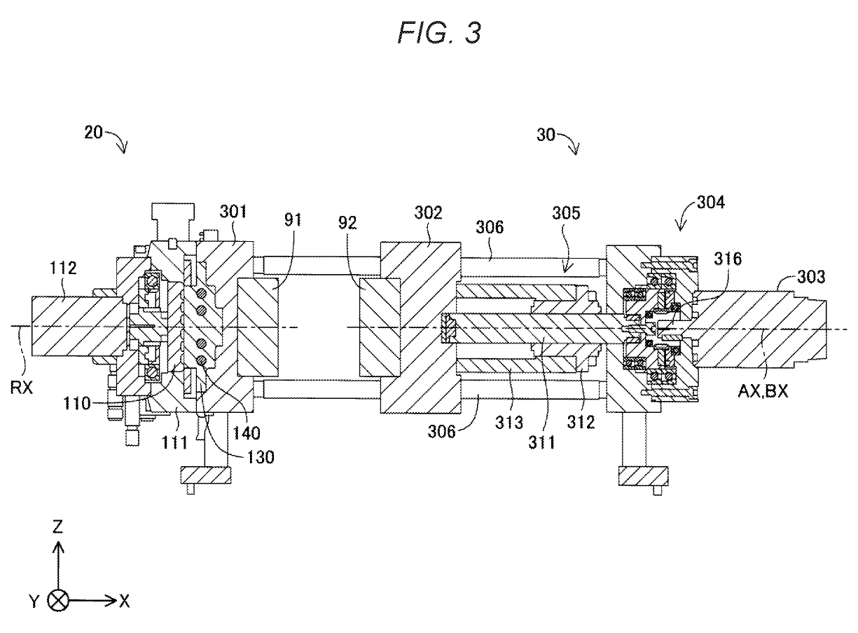

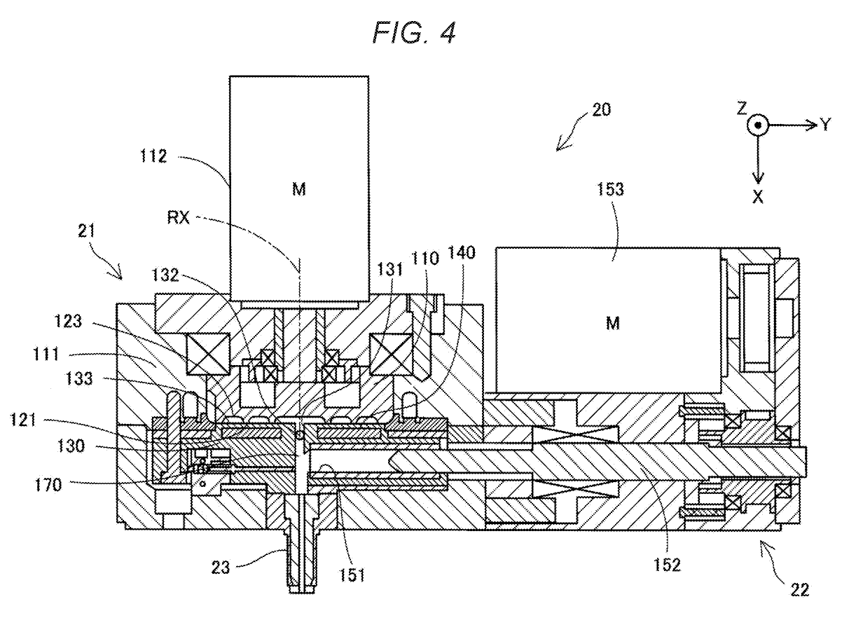

FIG. 3 is a cross-sectional view showing schematic configurations of the injection unit 20 and the mold opening and closing unit 30. FIG. 4 is another cross-sectional view showing the schematic configuration of the injection unit 20. The injection unit 20 includes a plasticizing unit 21, a suction feeding unit 22, and a nozzle 23.

The plasticizing unit 21 plasticizes at least a part of the material supplied from the hopper 60 to generate the molding material. The plasticizing unit 21 includes a flat screw 110, a barrel 130, and a heater 140. The flat screw 110 is housed in a screw case 111. The flat screw 110 is also called a rotor or simply called a screw. The flat screw 110 is rotationally driven by a drive motor 112 about a rotational axis RX inside the screw case 111. In the present embodiment, a direction of the rotational axis RX is along the X direction. A communication hole 131 is formed at the center of the barrel 130. The communication hole 131 forms at least a part of a flow path 170 through which the molding material flows. An injection cylinder 151 described later is coupled to the communication hole 131. The communication hole 131 is provided with a check valve 132 upstream of the injection cylinder 151. The rotation of the flat screw 110 by the drive motor 112 and heating by the heater 140 are controlled by the control unit 40.

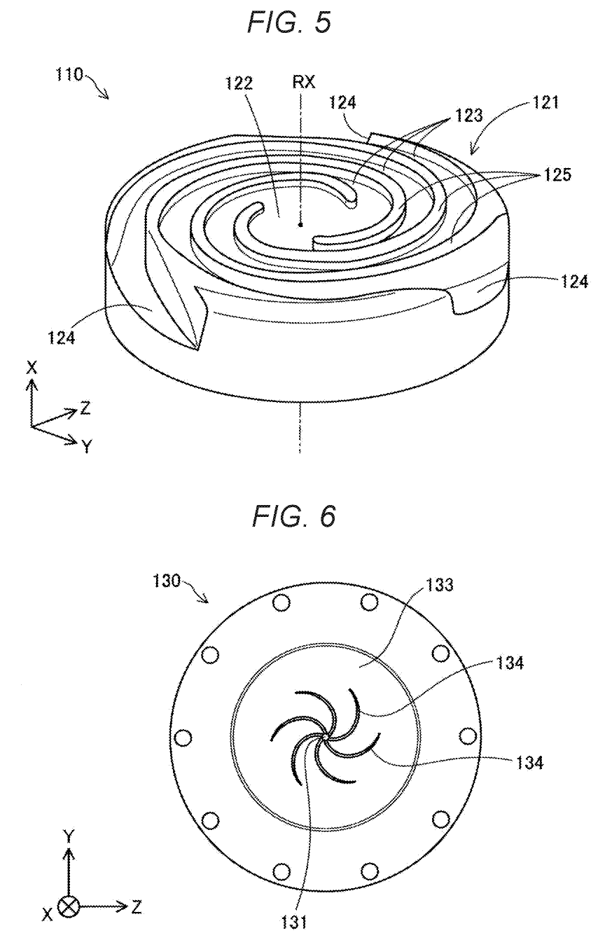

FIG. 5 is a perspective view showing a schematic configuration of the flat screw 110. The flat screw 110 has a substantially cylindrical shape whose height in a direction along the central axis thereof is smaller than a diameter. The flat screw 110 has a groove forming surface 121 facing the barrel 130, in which spiral grooves 123 are formed around a central portion 122. The grooves 123 communicate with a material inlet 124 formed in a side surface of the flat screw 110. The material supplied from the hopper 60 is supplied to the grooves 123 via the material inlets 124. The grooves 123 are formed by being separated by convex ridge portions 125. FIG. 5 illustrates an example in which the three grooves 123 are formed. However, the number of grooves 123 may be one, two, or more. Note that the shape of the groove 123 is not limited to the spiral shape and may be a helical shape or an involute curve shape or may be a shape extending so as to draw an arc from the central portion 122 toward the outer circumference.

FIG. 6 is a schematic plan view of the barrel 130. The barrel 130 has a counter surface 133 that faces the groove forming surface 121 of the flat screw 110. The communication hole 131 is formed at the center of the counter surface 133. A plurality of guide grooves 134 coupled to the communication hole 131 and extending in a spiral shape from the communication hole 131 toward the outer circumference are formed in the counter surface 133. The material supplied to the grooves 123 of the flat screw 110 flows along the grooves 123 and the guide grooves 134 according to the rotation of the flat screw 110 and is guided to the central portion 122 of the flat screw 110 while being plasticized between the flat screw 110 and the barrel 130 by the rotation of the flat screw 110 and heating by the heater 140. The material flowing into the central portion 122 flows out to the suction feeding unit 22 from the communication hole 131 formed at the center of the barrel 130. The guide grooves 134 are not necessarily provided in the barrel 130. Further, the guide grooves 134 are not necessarily coupled to the communication hole 131.

As shown in FIG. 4, the suction feeding unit 22 includes the injection cylinder 151, a plunger 152, and a plunger drive unit 153. The suction feeding unit 22 has a function of injecting the molding material within the injection cylinder 151 into a cavity defined between the fixed mold 91 and the movable mold 92. The suction feeding unit 22 controls an injection amount, an injection speed, and injection pressure of the molding material from the nozzle 23 under the control of the control unit 40. The injection cylinder 151 is a substantially cylindrical member coupled to the communication hole 131 of the barrel 130 and has the plunger 152 inside. The plunger 152 slides inside the injection cylinder 151 and pumps the molding material within the injection cylinder 151 into the nozzle 23 provided in the injection unit 20. The plunger 152 is driven by the plunger drive unit 153 including a motor.

The flow path 170 is formed in the nozzle 23. The plunger 152 pressure-feeds the molding material within the injection cylinder 151 into the nozzle 23, thereby injecting the molding material from the nozzle 23 to the mold 90. The nozzle 23 may be configured as an open-gate nozzle or a valve-gate type nozzle.

The mold opening and closing unit 30 shown in FIG. 3 opens and closes the mold 90 attached to the mold opening and closing unit 30. The mold opening and closing unit 30 includes a fixed mold attachment portion 301, a movable mold attachment portion 302, a mold opening and closing motor 303, a reducer 304, and a movement mechanism 305.

The fixed mold attachment portion 301 is fixed to end portions at the -X direction side of tie bars 306 extending in the X direction. The fixed mold 91 is attached to the fixed mold attachment portion 301. The fixed mold attachment portion 301 is provided with a through hole (not illustrated) for housing the nozzle 23. The mold opening and closing motor 303 and the reducer 304 are fixed to end portions at the +X direction side of the tie bars 306. The movable mold attachment portion 302 is disposed between the fixed mold attachment portion 301 and the reducer 304 so as to be movable along the extension direction of the tie bars 306. That is, the movable mold attachment portion 302 is provided to be movable toward and away from the fixed mold attachment portion 301. The movable mold 92 is attached to the movable mold attachment portion 302 so as to face the fixed mold 91.

The mold opening and closing motor 303 moves the movable mold attachment portion 302 along the mold clamping direction. The mold opening and closing motor 303 is, for example, a servo motor. The mold opening and closing motor 303 is controlled by the control unit 40. The reducer 304 reduces and transmits the rotation speed of the mold opening and closing motor 303 to the movement mechanism 305. The details of the reducer 304 will be described later.

The movement mechanism 305 moves the movable mold attachment portion 302 along the mold clamping direction by the driving force of the mold opening and closing motor 303. The movement mechanism 305 is provided between the movable mold attachment portion 302 and the reducer 304. In the present embodiment, the movement mechanism 305 is a ball screw having a screw shaft 311 and a nut 312. The screw shaft 311 is coupled to an output shaft 316 of the mold opening and closing motor 303 via the reducer 304. The screw shaft 311 rotates around an axis AX thereof by driving of the mold opening and closing motor 303. A direction along the axis AX is the X direction. In the present embodiment, the axis AX is aligned with an axis BX of the output shaft 316 of the mold opening and closing motor 303. The nut 312 is provided to be movable along the screw shaft 311, and moves in the X direction with the rotation of the screw shaft 311. The nut 312 is fixed to the movable mold attachment portion 302 via a cylindrical coupling member 313. Therefore, when the nut 312 moves in the X direction with the rotation of the screw shaft 311, the movable mold attachment portion 302 moves in the X direction.

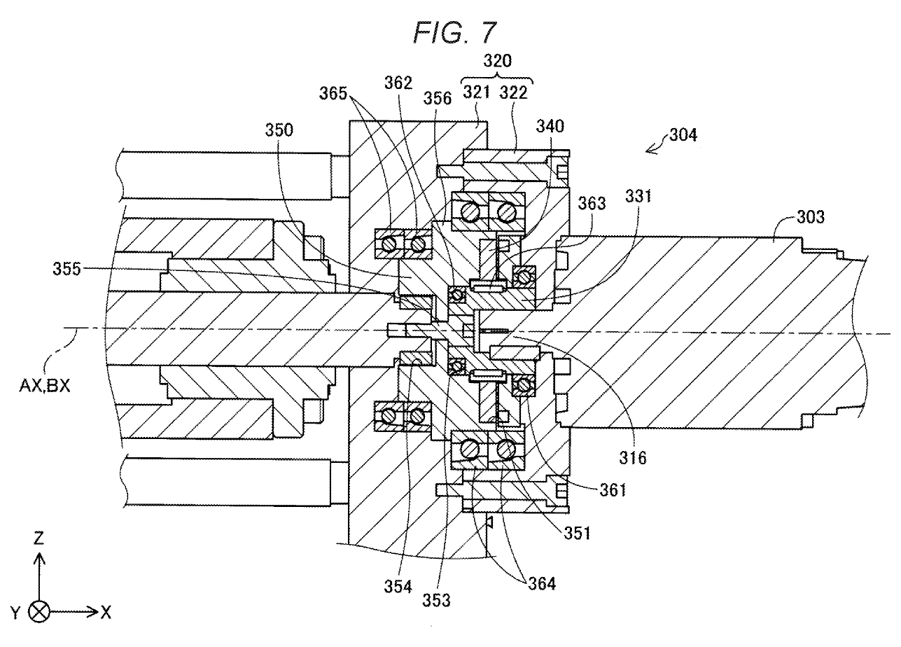

FIG. 7 shows a schematic configuration of the reducer 304. The reducer 304 is housed in a housing portion 320. The housing portion 320 includes a case 321 and a cover 322. The case 321 is a portion that houses to surround the reducer 304. The cover 322 is a portion disposed at the +X direction side of the case 321 so as to cover the reducer 304 from the side. The mold opening and closing motor 303 is disposed at the +X direction side of the cover 322 such that the output shaft 316 is inserted into the housing portion 320 through an opening provided in the cover 322. The reducer 304 in the present embodiment is a concentric shaft reducer in which the input shaft and the output shaft are coaxial. The reducer 304 includes a substantially cylindrical eccentric body 331 fixed to the output shaft 316 of the mold opening and closing motor 303, a first gear 340 configured as a planetary gear, and a second gear 350 configured as a sun internal gear.

An end portion of the eccentric body 331 at the mold opening and closing motor 303 side is pivotally supported by a first ball bearing 361 fixed to the cover 322. An end portion of the eccentric body 331 at the movement mechanism 305 side is pivotally supported by a second ball bearing 362 press-fitted into an inner circumference of the second gear 350. An outer circumference of a portion of the eccentric body 331 fixed to the first ball bearing 361 and an outer circumference of a portion fixed to the second ball bearing 362 have perfect circular shapes centered on the output shaft 316 of the mold opening and closing motor 303. In contrast, a portion of the eccentric body 331 sandwiched between the first ball bearing 361 and the second ball bearing 362 has a perfect circular shape having a central axis eccentric to the output shaft 316 of the mold opening and closing motor 303. Hereinafter, the eccentric body 331 simply refers to the portion of the eccentric body 331 sandwiched between the first ball bearing 361 and the second ball bearing 362.

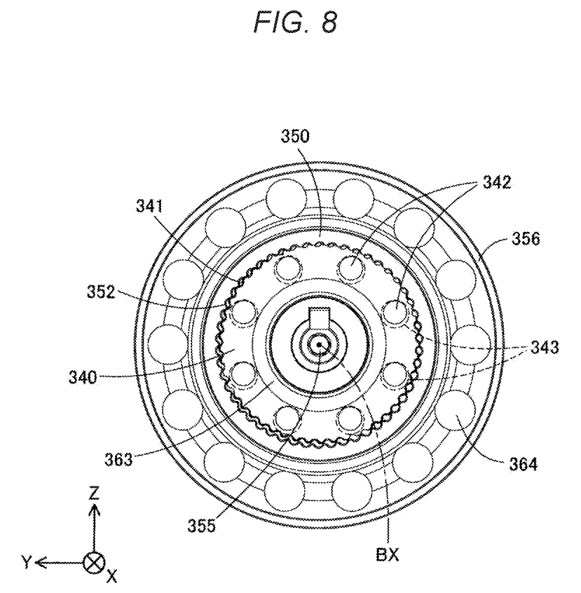

FIG. 8 is a plan view of the first gear 340 and the second gear 350 provided in the reducer 304 as viewed in the +X direction. The first gear 340 has an annular shape, and a needle bearing 363 is press-fitted and fixed to the inner circumference portion thereof. As shown in FIG. 8, wavy external teeth 341 are formed on the outer circumference of the first gear 340. A plurality of pins 342 are disposed on the first gear 340 at equal intervals in the circumferential direction when viewed in the +X direction. These pins 342 are respectively disposed in pin receiving recesses 343. A plurality of the pin receiving recesses 343 are formed in an annular pin receiving portion 332 fixed around the eccentric body 331 in the cover 322. Each of the pin receiving recesses 343 opens toward the -X direction side and has a diameter larger than the diameter of the pin 342. Therefore, the pin 342 can move in the Y direction and the Z direction, which are directions perpendicular to the axis BX, within the pin receiving recess 343.

As shown in FIG. 7, the second gear 350 has a substantially cylindrical shape. A first recess 351 is formed in an end surface of the second gear 350 at the +X direction side, and a second recess 353 is further formed in a bottom portion of the first recess 351. The first gear 340 is housed in the first recess 351. Wavy internal teeth 352 to be in contact with the external teeth 341 of the first gear 340 illustrated in FIG. 8 are formed on the inner circumference of the first recess 351. The second ball bearing 362 described above is press-fitted and fixed into the second recess 353.

A third recess 354 is formed in an end surface of the second gear 350 at the -X direction side. An end portion of the screw shaft 311 of the ball screw is fixed to the third recess 354 by a bolt 355 as a fixing portion. That is, the screw shaft 311 is integrated with the second gear 350. The second gear 350 and the screw shaft 311 may be fixed by another fixing portion such as a rivet instead of the bolt 355. The number of bolts 355 is not limited to one, and a plurality of bolts may be used to fix the second gear 350 and the screw shaft 311.

A flange-shaped restricting portion 356 is formed on the outer circumference of the second gear 350. The restricting portion 356 is a portion where the outer diameter of the second gear 350 is maximum. A portion of the second gear 350 at the +X direction side of the restricting portion 356 is pivotally supported by a third ball bearing 364 fixed to the cover 322 at the outer circumferential side of the pin receiving portion 332. Further, a portion of the second gear 350 at the -X direction side of the restricting portion 356 is pivotally supported by a fourth ball bearing 365 fixed to the case 321. The third ball bearing 364 and the fourth ball bearing 365 are configured as two single-row angular bearings.

The operation of the reducer 304 described above will be described. When the mold opening and closing motor 303 rotates, the eccentric body 331 fixed to the output shaft 316 of the mold opening and closing motor 303 rotates. The eccentric body 331 partially contacts the needle bearing 363 provided on the inner circumference of the first gear 340 while rotating. When the eccentric body 331 comes into contact with the needle bearing 363, the first gear 340 receives a driving force from the eccentric body 331 and swings in the Y direction and the Z direction intersecting the axis BX with the pins 342 housed in the pin receiving recesses 343. By the movement of the first gear 340, the external teeth 341 of the first gear 340 partially and sequentially come into contact with the internal teeth 352 of the second gear 350, the second gear 350 rotates at a predetermined reduction ratio determined by the number of the external teeth 341 of the first gear 340 and the number of the internal teeth 352 of the second gear 350, and the screw shaft 311 fixed to the second gear 350 rotates with the rotation. As a result, the movable mold attachment portion 302 moves along the mold clamping direction. In the present embodiment, the reduction ratio of the reducer 304 is 1/1000 or less. The speed at which the movable mold attachment portion 302 moves in the mold clamping direction and the mold opening direction with respect to the fixed mold attachment portion 301 is 10 mm/sec or less.

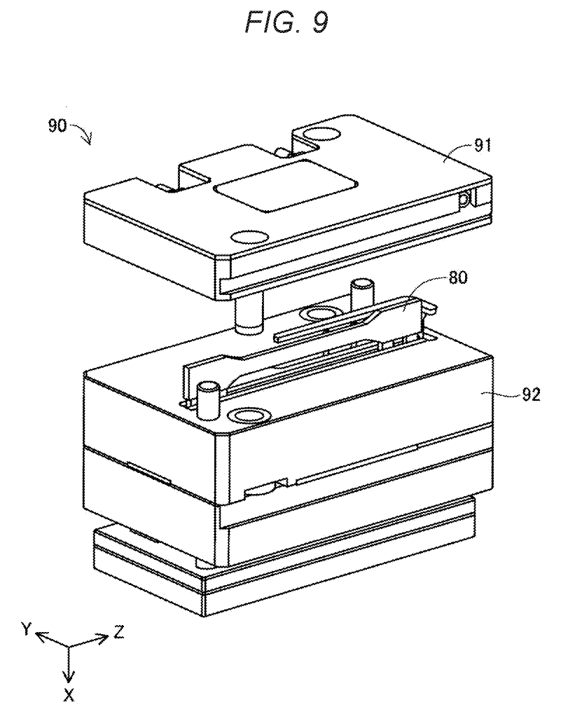

Hereinafter, the injection molding of the test piece 80 by the injection molding apparatus 10 and the inspection of the mechanical characteristics will be described. First, the injection molding apparatus 10 performs injection molding of the test piece 80 using the mold 90. FIG. 9 is a perspective view of the mold 90 used for molding the test piece 80. The injection molding of the test piece 80 is performed in a state where the fixed mold 91 and the movable mold 92 are attached to the fixed mold attachment portion 301 and the movable mold attachment portion 302, respectively. First, the control unit 40 controls the plasticizing unit 21 of the injection unit 20 to plasticize the material and produce the molding material. Then, the control unit 40 controls the mold opening and closing unit 30 to clamp the fixed mold 91 and the movable mold 92. Then, the control unit 40 controls the suction feeding unit 22 of the injection unit 20 to inject the molding material into the cavity having the shape of the test piece 80 partitioned by the fixed mold 91 and the movable mold 92. In the injection molding of the test piece 80, the control unit 40 causes the display unit 50 to display set values such as the injection pressure of the molding material, the temperature of the heater 140, and the mold clamping pressure.

Then, the injection molding apparatus 10 inspects the mechanical characteristics of the molded test piece 80. The injection molding apparatus 10 applies a compressive force or a tensile force to the test piece 80 by moving the movable mold attachment portion 302 relative to the fixed mold attachment portion 301 in a state where the test piece 80 is fixed between the fixed mold attachment portion 301 and the movable mold attachment portion 302. The inspection of the mechanical characteristics of the test piece 80 is performed in a state where a first fixing portion 410 and a second fixing portion 420 for fixing the test piece 80 are attached to the fixed mold attachment portion 301 and the movable mold attachment portion 302, respectively. The injection molding apparatus 10 may inspect the mechanical characteristics of the test piece 80 manufactured by an apparatus other than the injection molding apparatus 10.

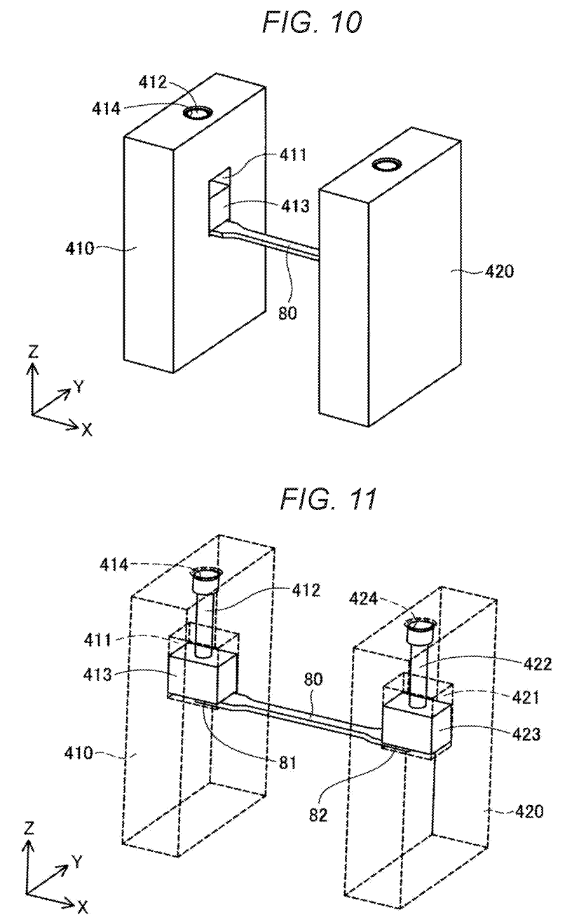

FIG. 10 is a perspective view of the first fixing portion 410 and the second fixing portion 420. FIG. 11 shows structures of the first fixing portion 410 and the second fixing portion 420. The fixed mold attachment portion 301 is configured such that the first fixing portion 410 can be attached thereto. The movable mold attachment portion 302 is configured such that the second fixing portion 420 can be attached thereto. The first fixing portion 410 and the second fixing portion 420 are attached to the fixed mold attachment portion 301 and the movable mold attachment portion 302 by bolts, clamp mechanisms, or the like, respectively.

The first fixing portion 410 fixes a first portion 81 of the test piece 80. The second fixing portion 420 fixes a second portion 82 of the test piece 80. Here, the first portion 81 is one end portion of the test piece 80 in the longitudinal direction, and the second portion 82 is the other end portion of the test piece 80 in the longitudinal direction. The first fixing portion 410 fixes the first portion 81 of the test piece 80 and the second fixing portion 420 fixes the second portion 82 of the test piece 80, thereby fixing the test piece 80 between the fixed mold attachment portion 301 and the movable mold attachment portion 302. The positions of the first portion 81 and the second portion 82 vary depending on the shape of the test piece 80. The positions of the first portion 81 and the second portion 82 are positions to be fixed in the inspection of the mechanical characteristics of the test piece 80.

The first fixing portion 410 has a clamp structure. In the present embodiment, the first fixing portion 410 includes a first fixing recess 411, a first bolt 412, a first pressing portion 413, and a first hole 414. The first fixing recess 411 is provided on a surface facing the second fixing portion 420 attached to the movable mold attachment portion 302 in a state where the first fixing portion 410 is attached to the fixed mold attachment portion 301. In the present embodiment, the first fixing recess 411 is provided on the surface at the +X direction side of the first fixing portion 410. The bottom surface of the first fixing recess 411 is parallel to the horizontal direction. The first pressing portion 413 is provided to be movable in the Z direction within the first fixing recess 411. The first hole 414 is formed above the first fixing recess 411 and penetrates a portion of the first fixing portion 410 located above the first fixing recess 411 in the Z direction. A screw groove is formed in the first hole 414. The first bolt 412 is inserted into the first hole 414 from above. By fastening the first bolt 412, the first pressing portion 413 is pushed by the lower end of the first bolt 412 and moves downward. As a result, the first portion 81 of the test piece 80 is sandwiched and fixed between the first pressing portion 413 and the bottom surface of the first fixing recess 411.

The second fixing portion 420 has a clamp structure. In the present embodiment, the second fixing portion 420 includes a second fixing recess 421, a second bolt 422, a second pressing portion 423, and a second hole 424. The second fixing recess 421 is provided on a surface facing the first fixing portion 410 attached to the fixed mold attachment portion 301 in a state where the second fixing portion 420 is attached to the movable mold attachment portion 302. In the present embodiment, the second fixing recess 421 is provided on the surface at the -X direction side of the second fixing portion 420. Since the second bolt 422, the second pressing portion 423, and the second hole 424 have the same configurations as the first bolt 412, the first pressing portion 413, and the first hole 414, respectively, the description thereof will be omitted. In the second fixing portion 420, similarly to the first fixing portion 410, the second portion 82 of the test piece 80 is sandwiched and fixed between the second pressing portion 423 and the bottom surface of the second fixing recess 421. The first fixing portion 410 and the second fixing portion 420 are not limited to the configuration that sandwiches and fixes the test piece 80 in the vertical direction, and may have a configuration that sandwiches and fixes the test piece in the horizontal direction or an oblique direction.

The control unit 40 performs inspection control for inspecting the mechanical characteristics of the test piece 80 in a state where the first fixing portion 410 attached to the fixed mold attachment portion 301 fixes the first portion 81 of the test piece 80 and the second fixing portion 420 attached to the movable mold attachment portion 302 fixes the second portion 82 of the test piece 80. In the inspection control, the control unit 40 applies a compressive force to the test piece 80 by moving the movable mold attachment portion 302 in the mold clamping direction with respect to the fixed mold attachment portion 301, or applies a tensile force to the test piece 80 by moving the movable mold attachment portion 302 in the mold opening direction with respect to the fixed mold attachment portion 301. In the inspection control, the control unit 40 calculates the compressive force or the tensile force applied to the test piece 80 based on a torque value of the mold opening and closing motor 303.

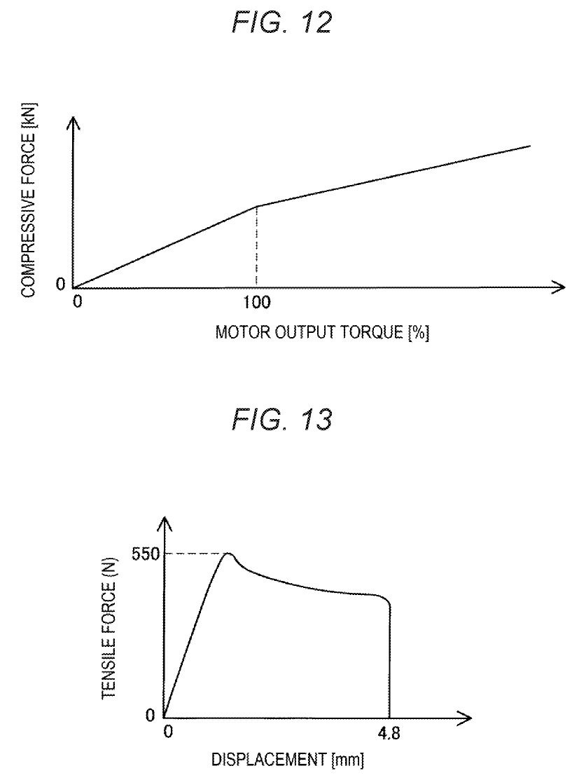

FIG. 12 is a graph showing an example of a relationship between the torque of the mold opening and closing motor 303 and the compressive force applied to the test piece 80. The compressive force applied to the test piece 80 increases as the torque of the mold opening and closing motor 303 increases. The increase amount of the compressive force with respect to the increase amount of the torque of the mold opening and closing motor 303 changes at a value of rated torque. In the example shown in FIG. 12, the rated torque is 100%. The value of the tensile force or the compressive force corresponding to the torque of the mold opening and closing motor 303 is stored in advance in the control unit 40.

The control unit 40 uses the compressive force or the tensile force applied to the test piece 80 to obtain a result of the inspection of the mechanical characteristics of the test piece 80. Here, the result of the inspection of the mechanical characteristics of the test piece 80 is, for example, a tensile strength, a creep strength, a Young's modulus, or the like of the test piece 80. The control unit 40 causes the display unit 50 to display the result of the inspection of the mechanical characteristics of the test piece 80.

FIG. 13 shows an example of a result of the inspection of the mechanical characteristics of the test piece 80. In FIG. 13, the horizontal axis indicates a displacement amount of the test piece 80 in a tensile test, and the vertical axis indicates the tensile force applied to the test piece 80. The control unit 40 causes the display unit 50 to display the graph illustrated in FIG. 13.

The second gear 350 of the reducer 304 illustrated in FIG. 7 is subjected to a load in the +X direction as the mold opening direction from the screw shaft 311 by the mold opening and closing motor 303 driving to move the movable mold attachment portion 302 in the mold clamping direction in the mold clamping operation in the injection molding of the molded article and the compression operation of the test piece 80 in the inspection of the mechanical characteristics of the test piece 80. Concurrently, the second gear 350 is supported by the third ball bearing 364. That is, the third ball bearing 364 is subjected to a load in the mold opening direction applied from the screw shaft 311 to the second gear 350. The second gear 350 of the reducer 304 is subjected to a load in the -X direction as the mold clamping direction from the screw shaft 311 by the mold opening and closing motor 303 driving to move the movable mold attachment portion 302 in the mold opening direction in the tensile operation of the test piece 80 in the inspection of the mechanical characteristics of the test piece 80. Concurrently, the second gear 350 is supported by the fourth ball bearing 365. That is, the fourth ball bearing 365 is subjected to a load in the mold clamping direction applied from the screw shaft 311 to the second gear 350. The reducer 304 is provided such that a withstand load against a load applied to the reducer 304 in the mold clamping direction is equal to or greater than a withstand load against a load applied to the reducer 304 in the mold opening direction. In the present embodiment, the withstand load of the fourth ball bearing 365 in the mold clamping direction is equal to or greater than the withstand load of the third ball bearing 364 in the mold opening direction.

According to the first embodiment described above, the injection molding apparatus 10 performs injection molding of the test piece 80 using the mold 90 including the fixed mold 91 and the movable mold 92. In the injection molding of the test piece 80, the fixed mold 91 is attached to the fixed mold attachment portion 301, and the movable mold 92 is attached to the movable mold attachment portion 302. Further, the control unit 40 performs inspection control for inspecting the mechanical characteristics of the test piece 80 in the state where the first fixing portion 410 attached to the fixed mold attachment portion 301 fixes the first portion 81 of the test piece 80 and the second fixing portion 420 attached to the movable mold attachment portion 302 fixes the second portion 82 of the test piece 80. In the inspection control, the control unit 40 applies a compressive force to the test piece 80 by moving the movable mold attachment portion 302 in the mold clamping direction with respect to the fixed mold attachment portion 301, or applies a tensile force to the test piece 80 by moving the movable mold attachment portion 302 in the mold opening direction with respect to the fixed mold attachment portion 301. Therefore, in the injection molding apparatus 10 that performs injection molding of the test piece 80, the mechanical characteristics of the test piece 80 can be inspected. Thus, the number of facilities necessary for manufacturing the test piece 80 and inspecting the mechanical characteristics can be reduced.

In the present embodiment, in the inspection control, the control unit 40 calculates the compressive force or the tensile force applied to the test piece 80 based on the torque value of the mold opening and closing motor 303. Therefore, the mechanical characteristics of the test piece 80 can be inspected using the mold opening and closing motor 303 provided in the injection molding apparatus 10 without adding a measurement mechanism for measuring the compressive force or the tensile force applied to the test piece 80 to the injection molding apparatus 10.

In the present embodiment, the injection molding apparatus 10 further includes the display unit 50 that displays information on the operation of the injection molding apparatus 10, and the control unit 40 causes the display unit 50 to display the result of the inspection of the mechanical characteristics of the test piece 80. Therefore, a user can confirm the inspection result without preparing another display device for displaying the result of the inspection of the mechanical characteristics of the test piece 80.

In the present embodiment, the speed at which the movable mold attachment portion 302 moves in the mold clamping direction and the mold opening direction with respect to the fixed mold attachment portion 301 is 10 mm/sec or less. In a general injection molding apparatus, it is required to operate the movable mold attachment portion 302 at a high speed in order to improve productivity of the molded article, but high productivity is not required in injection molding of the test piece 80. In the present embodiment, the position of the movable mold attachment portion 302 can be determined with high accuracy, and the compressive force or the tensile force applied to the test piece 80 can be controlled with high accuracy in the inspection of the mechanical characteristics of the test piece 80. Therefore, the accuracy of the inspection of the mechanical characteristics of the test piece 80 can be improved.

In the present embodiment, the mold opening and closing unit 30 further includes the movement mechanism 305 that moves the movable mold attachment portion 302 along the mold clamping direction by the driving force of the mold opening and closing motor 303, and the reducer 304 that reduces and transmits the rotation speed of the mold opening and closing motor 303 to the movement mechanism 305, and the reduction ratio of the reducer 304 is 1/1000 or less. Therefore, the position of the movable mold attachment portion 302 can be determined with high accuracy, and the compressive force or the tensile force applied to the test piece 80 can be controlled with high accuracy in the inspection of the mechanical characteristics of the test piece 80. Thus, the accuracy of the inspection of the mechanical characteristics of the test piece 80 can be improved.

In the present embodiment, the mold opening and closing unit 30 further includes the movement mechanism 305 that moves the movable mold attachment portion 302 along the mold clamping direction by the driving force of the mold opening and closing motor 303, and the reducer 304 that reduces and transmits the rotation speed of the mold opening and closing motor 303 to the movement mechanism 305, and the withstand load of the reducer 304 against the load applied to the reducer 304 in the mold clamping direction is equal to or greater than the withstand load against the load applied to the reducer 304 in the mold opening direction. Therefore, in the inspection of the mechanical characteristics of the test piece 80, the tensile force larger than the compressive force can be applied to the test piece 80.

In the present embodiment, the first fixing portion 410 and the second fixing portion 420 have the clamp structure. Therefore, the mechanical characteristics of the test piece 80 can be inspected with a simple configuration of the first fixing portion 410 and the second fixing portion 420.

### B. Other Embodiments:

(B-1) In the above embodiment, the withstand load of the fourth ball bearing 365 in the mold clamping direction is set to be equal to or greater than the withstand load of the third ball bearing 364 in the mold opening direction, so that the withstand load of the reducer 304 against the load applied to the reducer 304 in the mold clamping direction is set to be equal to or greater than the withstand load against the load applied to the reducer 304 in the mold opening direction. In contrast, the reducer 304 may be provided such that the withstand load against the load applied to the reducer 304 in the mold clamping direction is equal to or greater than the withstand load against the load applied to the reducer 304 in the mold opening direction by adjusting the thickness of each portion in the direction along the mold clamping direction.

(B-2) In the above embodiment, in the inspection control, the control unit 40 calculates the compressive force or the tensile force applied to the test piece 80 based on the torque value of the mold opening and closing motor 303. In contrast, in the inspection control, the control unit 40 may not calculate the compressive force or the tensile force applied to the test piece 80 based on the torque value of the mold opening and closing motor 303.

(B-3) In the above embodiment, the control unit 40 causes the display unit 50 to display the result of the inspection of the mechanical characteristics of the test piece 80. In contrast, the control unit 40 may not cause the display unit 50 to display the result of the inspection of the mechanical characteristics of the test piece 80.

(B-4) In the above embodiment, the speed at which the movable mold attachment portion 302 moves in the mold clamping direction and the mold opening direction with respect to the fixed mold attachment portion 301 is 10 mm/sec or less. In contrast, the speed at which the movable mold attachment portion 302 moves in the mold clamping direction and the mold opening direction with respect to the fixed mold attachment portion 301 may be faster than 10 mm/sec.

(B-5) In the above embodiment, the reduction ratio of the reducer 304 is 1/1000 or less. In contrast, the reduction ratio of the reducer 304 may be larger than 1/1000.

(B-6) In the above embodiment, the withstand load of the reducer 304 against the load applied to the reducer 304 in the mold clamping direction is equal to or greater than the withstand load against the load applied to the reducer 304 in the mold opening direction. In contrast, the withstand load of the reducer 304 against the load applied to the reducer 304 in the mold clamping direction may be less than the withstand load against the load applied to the reducer 304 in the mold opening direction.

(B-7) In the above embodiment, the first fixing portion 410 and the second fixing portion 420 have the clamp structure. In contrast, the first fixing portion 410 and the second fixing portion 420 may have a structure capable of fixing the test piece 80 instead of the clamp structure.

(B-8) The above disclosure may be implemented in the form of a mold opening and closing device including the mold opening and closing unit 30 and the control unit 40 instead of the injection molding apparatus 10.

### C. Other Configurations:

The present disclosure is not limited to the embodiments described above, and can be implemented in various aspects without departing from the spirit of the present disclosure. For example, the present disclosure may also be implemented in following aspects. To solve a part or all of the problems of the present disclosure, or to achieve a part or all of the advantages of the present disclosure, the technical features in the above embodiments corresponding to technical features in the following aspects can be replaced or combined as appropriate. In addition, the technical features can be deleted as appropriate unless described as essential features in the present specification.

(1) According to a first aspect of the present disclosure, an injection molding apparatus is provided. The injection molding apparatus is an injection molding apparatus that performs injection molding of a test piece using a mold including a fixed mold and a movable mold, including an injection unit that injects a material of the test piece into the mold, a mold opening and closing unit to which the mold is attached and that opens and closes the mold, and a control unit that controls the injection unit and the mold opening and closing unit, wherein the mold opening and closing unit includes a fixed mold attachment portion to which the fixed mold is attached, a movable mold attachment portion movable toward and away from the fixed mold attachment portion in a mold clamping direction, to which the movable mold is attached, and a mold opening and closing motor for moving the movable mold attachment portion along the mold clamping direction, a first fixing portion that fixes the test piece is attachable to the fixed mold attachment portion, a second fixing portion that fixes the test piece is attachable to the movable mold attachment portion, and the control unit performs inspection control to inspect mechanical characteristics of the test piece by applying a compressive force to the test piece by moving the movable mold attachment portion in the mold clamping direction with respect to the fixed mold attachment portion or applying a tensile force to the test piece by moving the movable mold attachment portion in a mold opening direction opposite to the mold clamping direction with respect to the fixed mold attachment portion in a state where the first fixing portion attached to the fixed mold attachment portion fixes a first portion of the test piece and the second fixing portion attached to the movable mold attachment portion fixes a second portion of the test piece different from the first portion.

According to the configuration, since the mechanical characteristics of the test piece can be inspected in the injection molding apparatus that performs injection molding of the test piece, the number of facilities necessary for manufacturing the test piece and inspecting the mechanical characteristics can be reduced.

(2) In the above aspect, the control unit may calculate the compressive force or the tensile force applied to the test piece based on a torque value of the mold opening and closing motor in the inspection control.

According to the configuration, the mechanical characteristics of the test piece can be inspected without adding a measurement mechanism for measuring the compressive force or the tensile force applied to the test piece to the injection molding apparatus.

(3) In the above aspect, the apparatus may further include a display unit that displays information on an operation of the injection molding apparatus, wherein the control unit may cause the display unit to display a result of the inspection of the mechanical characteristics of the test piece.

According to the configuration, the user can confirm the inspection result without preparing another display device for displaying the result of the inspection of the mechanical characteristics of the test piece.

(4) In the above aspect, a speed at which the movable mold attachment portion moves in the mold clamping direction and the mold opening direction with respect to the fixed mold attachment portion may be 10 mm/sec or less.

According to the configuration, the position of the movable mold attachment portion can be determined with high accuracy, and the compressive force or the tensile force applied to the test piece can be controlled with high accuracy in the inspection of the mechanical characteristics of the test piece. Therefore, the accuracy of the inspection of the mechanical characteristics of the test piece can be improved.

(5) In the aspect described above, the mold opening and closing unit may further include a movement mechanism that moves the movable mold attachment portion along the mold clamping direction by a driving force of the mold opening and closing motor, and a reducer that reduces and transmits a rotation speed of the mold opening and closing motor to the movement mechanism, and a reduction ratio of the reducer may be 1/1000 or less.

According to the configuration, the position of the movable mold attachment portion can be determined with high accuracy, and the compressive force or the tensile force applied to the test piece can be controlled with high accuracy in the inspection of the mechanical characteristics of the test piece. Therefore, the accuracy of the inspection of the mechanical characteristics of the test piece can be improved.

(6) In the aspect described above, the mold opening and closing unit may further include a movement mechanism that moves the movable mold attachment portion along the mold clamping direction by a driving force of the mold opening and closing motor, and a reducer that reduces and transmits a rotation speed of the mold opening and closing motor to the movement mechanism, and a withstand load of the reducer against a load applied to the reducer in the mold clamping direction may be equal to or greater than a withstand load against a load applied to the reducer in the mold opening direction.

According to the configuration, in the inspection of the mechanical characteristics of the test piece, the tensile force larger than the compressive force can be applied to the test piece.

(7) In the above aspect, the first fixing portion and the second fixing portion may have a clamp structure.

According to the configuration, the mechanical characteristics of the test piece can be inspected with a simple configuration of the first fixing portion and the second fixing portion.

(8) According to a second aspect of the present disclosure, a mold opening and closing device is provided. The mold opening and closing device is a device to which a mold including a fixed mold and a movable mold is attached and that opens and closes the mold, including a fixed mold attachment portion to which the fixed mold is attached, a movable mold attachment portion movable toward and away from the fixed mold attachment portion in a mold clamping direction, to which the movable mold is attached, a mold opening and closing motor for moving the movable mold attachment portion along the mold clamping direction, and a control unit that controls the mold opening and closing motor, wherein a first fixing portion that fixes a test piece is attachable to the fixed mold attachment portion, a second fixing portion that fixes the test piece is attachable to the movable mold attachment portion, and the control unit performs inspection control to inspect mechanical characteristics of the test piece by applying a compressive force to the test piece by moving the movable mold attachment portion in the mold clamping direction with respect to the fixed mold attachment portion or applying a tensile force to the test piece by moving the movable mold attachment portion in a mold opening direction opposite to the mold clamping direction with respect to the fixed mold attachment portion in a state where the first fixing portion attached to the fixed mold attachment portion fixes a first portion of the test piece and the second fixing portion attached to the movable mold attachment portion fixes a second portion of the test piece different from the first portion.

According to the configuration, since the mechanical characteristics of the test piece can be inspected using the mold opening and closing device used for injection molding of the test piece, the number of facilities necessary for manufacturing the test piece and inspecting the mechanical characteristics can be reduced.

What is claimed is:

1. An injection molding apparatus that performs injection molding of a test piece using a mold including a fixed mold and a movable mold, the apparatus comprising:
an injection unit that injects a material of the test piece into the mold;
a mold opening and closing unit to which the mold is attached and that opens and closes the mold; and
a control unit that controls the injection unit and the mold opening and closing unit, wherein
the mold opening and closing unit includes
a fixed mold attachment portion to which the fixed mold is attached,
a movable mold attachment portion movable toward and away from the fixed mold attachment portion in a mold clamping direction, to which the movable mold is attached, and
a mold opening and closing motor for moving the movable mold attachment portion along the mold clamping direction,
a first fixing portion that fixes the test piece is attachable to the fixed mold attachment portion,
a second fixing portion that fixes the test piece is attachable to the movable mold attachment portion, and
the control unit performs inspection control to inspect mechanical characteristics of the test piece by applying a compressive force to the test piece by moving the movable mold attachment portion in the mold clamping direction with respect to the fixed mold attachment portion or applying a tensile force to the test piece by moving the movable mold attachment portion in a mold opening direction opposite to the mold clamping direction with respect to the fixed mold attachment portion in a state where the first fixing portion attached to the fixed mold attachment portion fixes a first portion of the test piece and the second fixing portion attached to the movable mold attachment portion fixes a second portion of the test piece different from the first portion.

2. The injection molding apparatus according to claim 1, wherein
the control unit calculates the compressive force or the tensile force applied to the test piece based on a torque value of the mold opening and closing motor in the inspection control.

3. The injection molding apparatus according to claim 1, further comprising a display unit that displays information on an operation of the injection molding apparatus, wherein
the control unit causes the display unit to display a result of the inspection of the mechanical characteristics of the test piece.

4. The injection molding apparatus according to claim 1, wherein
a speed at which the movable mold attachment portion moves in the mold clamping direction and the mold opening direction with respect to the fixed mold attachment portion is 10 mm/sec or less.

5. The injection molding apparatus according to claim 1, wherein
the mold opening and closing unit further includes:
a movement mechanism that moves the movable mold attachment portion along the mold clamping direction by a driving force of the mold opening and closing motor; and
a reducer that reduces and transmits a rotation speed of the mold opening and closing motor to the movement mechanism, and
a reduction ratio of the reducer is 1/1000 or less.

6. The injection molding apparatus according to claim 1, wherein
the mold opening and closing unit further includes:
a movement mechanism that moves the movable mold attachment portion along the mold clamping direction by a driving force of the mold opening and closing motor; and
a reducer that reduces and transmits a rotation speed of the mold opening and closing motor to the movement mechanism, and
a withstand load of the reducer against a load applied to the reducer in the mold clamping direction is equal to or greater than a withstand load against a load applied to the reducer in the mold opening direction.

7. The injection molding apparatus according to claim 1, wherein
the first fixing portion and the second fixing portion have a clamp structure.

8. A mold opening and closing device to which a mold including a fixed mold and a movable mold is attached and that opens and closes the mold, the device comprising:
a fixed mold attachment portion to which the fixed mold is attached;
a movable mold attachment portion movable toward and away from the fixed mold attachment portion in a mold clamping direction, to which the movable mold is attached;
a mold opening and closing motor for moving the movable mold attachment portion along the mold clamping direction; and
a control unit that controls the mold opening and closing motor, wherein
a first fixing portion that fixes a test piece is attachable to the fixed mold attachment portion,
a second fixing portion that fixes the test piece is attachable to the movable mold attachment portion, and
the control unit performs inspection control to inspect mechanical characteristics of the test piece by applying a compressive force to the test piece by moving the movable mold attachment portion in the mold clamping direction with respect to the fixed mold attachment portion or applying a tensile force to the test piece by moving the movable mold attachment portion in a mold opening direction opposite to the mold clamping direction with respect to the fixed mold attachment portion in a state where the first fixing portion attached to the fixed mold attachment portion fixes a first portion of the test piece and the second fixing portion attached to the movable mold attachment portion fixes a second portion of the test piece different from the first portion.
